(19) United States
(12) Patent Application Publication
(10) Pub. No.: US 2026/0002909 A1
(43) Pub. Date: Jan. 1, 2026

(54) QANTITATIVE DETECTION METHOD OF MICRO-DEFECTS THROUGH LOW-FREQUENCY ULTRASONIC MULTI-RESOLUTION SCANNING IMAGING

(71) Applicant: DALIAN UNIVERSITY OF TECHNOLOGY, Dalian, Liaoning (CN)

(72) Inventors: Zhiyuan MA, Dalian, Liaoning (CN); Li LIN, Dalian, Liaoning (CN)

(21) Appl. No.: 18/876,433

(22) PCT Filed: Jan. 17, 2024
(86) PCT No.: PCT/CN2024/072695

§ 371 Date: Dec. 18, 2024

(30) Foreign Application Priority Data
Dec. 27, 2023 (CN) 202311823697.8

(51) Int. Cl. G01N 29/06; G01N 29/44; G01N 29/46

(52) U.S. Cl. CPC G01N 29/0654; G01N 29/4454; G01N 29/449; G01N 29/46; G01N 2291/0289

(57) ABSTRACT

In a quantitative detection method of micro-defects through low-frequency ultrasonic multi-resolution scanning imaging, the collected ultrasonic A-type scanning signals are decomposed through split spectrum processing into sub-signals with different center frequencies fᵢ, amplitude imaging is performed on the same sub-signals fᵢ, a defect size dᵢ detected by a half of the amplitude of the image is identified, linear fitting is performed on dᵢ with fᵢ according to the sound field directivity function, and dᵢ corresponding to the slope k=−0.01 of the fitting curve is the quantitative size of the defect.

### TECHNICAL FIELD

The present invention relates to a quantitative detection method of micro-defects through low-frequency ultrasonic multi-resolution scanning imaging, belonging to the technical field of ultrasonic non-destructive testing.

### BACKGROUND ART

Since the comprehensive influence of factors such as material characteristics, process parameters and surrounding environment, micro-defects such as pores, cracks and poor fusion are often formed inside high-performance parts during its preparation process. There is a large stress concentration around micro-defects, which can weaken the tensile strength, impact resistance, fatigue strength and the like of the parts. Therefore, quantitative non-destructive testing of micro-defects is crucial to ensure key performance indexes of the parts.

Ultrasonic testing has the advantages of automatic scanning, real-time imaging, simple equipment, harmlessness to human bodies and the like, and has been widely used in various fields. For example, Chabot in France used phased array ultrasonic technology to test and study aluminum alloy samples made by laser melting deposition. This technology can test an artificially prefabricated pore defect with a diameter of Φ 0.6-1.0 mm. However, due to the limitation of low frequency (10 MHZ) and large aperture (38.4 mm) of a phased array probe, it is difficult to accurately quantify the defect with a diameter below Φ 0.6 mm. Zhang Chi et al. used a water immersion point focusing probe with a center frequency of 20 MHz and a focal column diameter of 0.44 mm to detect titanium alloy defects through ultrasonic C-scanning. Results showed that the defect with a size smaller than 0.40 mm had a low detection rate and a quantitative error was large. Studies pointed out that when the defect size was smaller than the focal column diameter, the reflected echo energy was significantly reduced, which seriously affected the detection of defect and the quantitative accuracy of defect size. Traditional phased array ultrasonic testing and ultrasonic C-scanning testing can improve the lateral resolution of scanning imaging to some extent by increasing a probe aperture, improving a probe frequency, and reducing a focal length, and improve the detection capability and quantitative accuracy of micro-defects. However, it is still impossible to quantify micro-defects smaller than the resolution, and meanwhile, there are new problems such as a reduced signal-to-noise ratio, an insufficient detection depth, a difficulty in quantifying a defect far away from a focal position.

### SUMMARY

In order to solve the problems existing in the prior art, the present invention provides a quantitative detection method of micro-defects through low-frequency ultrasonic multi-resolution scanning imaging, which can solve the contradiction that a lateral resolution and a detection depth are difficult to be satisfied simultaneously in traditional ultrasonic C-scanning imaging testing, push the limitation that low probe frequency and large aperture size of phased array ultrasonic imaging testing makes it difficult to quantify the defect sizes of hundreds of microns, and also overcome the problems of relatively high price, complicated operation, limited detection depth and difficulty to apply in engineering of an ultrasonic microscope and other equipment. The method of the present invention has a wider application range, is simple and practicable in engineering application, can be applied to all ultrasonic scanning imaging testing technologies, and has great economic and social benefits.

A technical solution adopted by the present invention to solve the technical problems is a quantitative detection method of micro-defects through low-frequency ultrasonic multi-resolution scanning imaging, including the following steps of:
(1) Calibrating an ultrasonic detector, a low-frequency ultrasonic probe and a stepping encoder, encoding and scanning an object to be detected, and collecting ultrasonic A-type echo signals x(t) at M groups of encoded positions;
(2) Performing fast Fourier transform on the acquired echo signals x(t) to obtain an amplitude spectrum A(f) thereof, identifying an effective frequency band [fᵢ, fᵤ] corresponding to half the height of amplitude of the A(f), equally dividing the effective frequency band into N filter bands with a center frequency fᵢ, wherein i is a natural number from 1 to N;
(3) Performing band-pass filtering with the center frequency fᵢ on the signals x(t) using split spectrum processing to decompose the signals x(t) into N sub-signals yᵢ(t) with different center frequencies fᵢ, wherein a filtering bandwidth bi is determined according to a condition that a sub-signal energy Eᵢ and a total energy E of the signals x(t) satisfy 10 lg(E/Ei)<signal-to-noise ratio;
(4) Performing amplitude imaging on sub-signals yᵢ(t) with the same center frequency fᵢ at the M groups of encoded positions to obtain N multi-resolution scanning images Imᵢ with different frequency characteristics;
(5) Sequentially identifying a defect size dᵢ detected with half the amplitude of each of the resolution scanning images Imᵢ, and drawing a curve of the defect sizes dᵢ detected by N ultrasonic scanning images Imᵢ changing with the fᵢ;
(6) Deriving a directivity function D_{c} of the ultrasonic probe based on the acoustic reciprocal principle, wherein the directivity function D_{c} is determined through numerical simulation, as shown in formula (1):

$${D}_{C , PE} ( θ ) = {jinc}^{2} ( π \frac{D}{λ} sin θ ) \qquad ( 1 )$$

wherein, D represents a size of the probe, having a unit of mm, λ represents a wavelength of a sound wave in a material, having a unit of mm, and θ represents a diffusion angle of the sound wave, having a unit of radian;
(7) Determining, at a position where a sound velocity of the object to be detected being of ν and a detected depth being of A, a sound beam width corresponding to half the maximum amplitude of D_{c}, that is the defect size dᵢ detected by each the resolution ultrasonic scanning image Imᵢ, and obtaining, according to λf=ν, a quantitative relationship between the detected defect size dᵢ and the center frequency fᵢ, satisfying:

$${d}_{i} = \frac{A}{\sqrt{{( \frac{π D}{1.616 λ} )}^{2} - 1}} = \frac{A}{\sqrt{C \cdot {f}_{i}^{2} - 1}} \qquad ( 2 )$$

$$C = {( \frac{π D}{1.616 v} )}^{2} \qquad ( 3 )$$

(8) Substituting a known size D of the ultrasonic probe and a sound velocity ν of a part into formula (2), and linearly fitting the curve of the defect size dᵢ changing with the fᵢ detected in step (5) to determine the unknown parameter A in formula (2);
(9) Determining, based on the fitted curve, a resolution frequency fₖ corresponding to a slope k=−0.01;

If an updated sub-signal energy Eᵢ of the split spectrum processing in the bandwidth [fₖ, fᵤ] satisfies a condition of 10 lg(E/Eᵢ)<signal-to-noise ratio, determining a new bandwidth b through the resolution frequency fₖ, drawing a new scanning image Im, and re-obtaining a quantitative size dₖ of the defect; and

If the resolution frequency fₖ is not in the effective frequency band or the condition of 10 lg(E/Eᵢ)<signal-to-noise ratio is not satisfied, extrapolating the fitted curve against the frequency f and deriving it, and the detected defect size dₖ corresponding to the slope k=−0.01 is the quantitative size of the defect.

The present invention has the following effects and benefits:

The present invention provides a quantitative detection method of micro-defects through low-frequency ultrasonic multi-resolution scanning imaging, which only uses a conventional low-frequency ultrasonic probe for encoding and scanning detection, and a multi-resolution scanning image is obtained in combination with split spectrum processing and the defect size in each resolution scanning image is detected, and the sizes of all detected defects may be accurately quantified according to the directivity function of the ultrasonic probe. The method of the present invention can improve the signal-to-noise ratio, detection depth and lateral resolution of the micro-defects at the same time, and achieve a quantitative detection effect of 3-times high-frequency ultrasound through low-frequency ultrasound. The method of the present invention overcomes the limitations that a probe resolution needs to be smaller than the defect size in a “−6 dB method” and a large number of reference blocks are needed in an “equivalent method”, also overcomes the limitations of large attenuation, low signal-to-noise ratio and insufficient detection depth of a high-frequency focusing probe, and further avoids the limitations of size and shape of the ultrasonic probe and the scanning imaging method, having strong engineering applicability. The method of the present invention overcomes the contradiction that a resolution and a detection depth are difficult to be satisfied simultaneously in traditional ultrasonic C-scanning imaging detection, also push the limitation that low probe frequency and large aperture size of phased array ultrasonic imaging testing makes it difficult to quantify the defect sizes of hundreds of microns, and solves the problems of relatively high price, complicated operation, limited detection depth and difficulty to apply in engineering of an ultrasonic microscope and other equipment. The method of the present invention has a wider application scope, and is simple and practicable in engineering application, which can be popularized and applied to all ultrasonic scanning imaging testing technologies, and has greater economic and social benefits.

### BRIEF DESCRIPTION OF THE DRAWINGS

FIG. 1 shows a schematic diagram of an ultrasonic C-scanning testing system.

FIG. 2 shows an ultrasonic A-type echo signals x(t) at encoded positions by the ultrasonic detection system.

FIG. 3 shows an amplitude spectrum A(f) of the ultrasonic A-type echo signals x(t).

FIG. 4 shows multi-resolution low-frequency ultrasonic scanning images Imᵢ, wherein the center frequency in FIG. 4(a) is fᵢ, the center frequency in FIG. 4(b) is f₂, the center frequency in FIG. 4(c) is f₁₂, and the center frequency in FIG. 4(d) is f₁₃.

FIG. 5 is a curve of the detected size dᵢ of a defect with a nominal size of Φ200 μm changing with fᵢ.

FIG. 6 shows results of multi-resolution low-frequency ultrasonic C-scanning imaging testing of different defects: (a) a defect of Φ800 μm, and (b) a defect of Φ200 μm.

FIG. 7 shows a curve of a defect size dᵢ of a defect with a nominal size of Φ300 μm in multi-resolution ultrasonic C-scanning imaging detection changing with fᵢ.

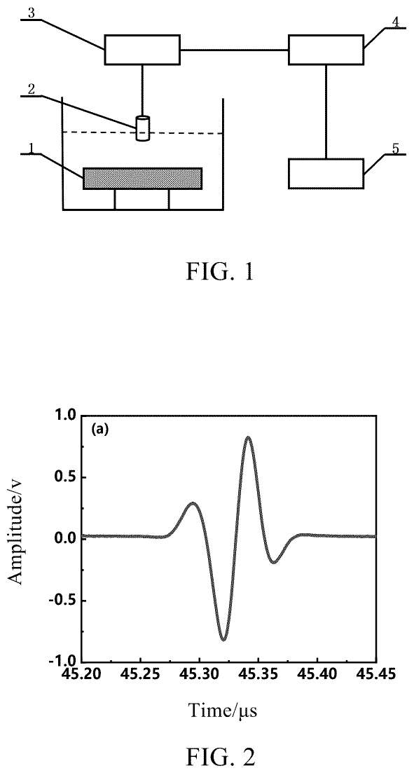

In FIG. 1: 1—3D printed nickel-based superalloy sample, 2—low-frequency ultrasonic probe, 3—XYZ three-dimensional stepping encoder, 4—ultrasonic detector, 5—computer with signal processing software.

### DETAILED DESCRIPTION OF THE EMBODIMENTS

The technical solutions in the embodiments of the present invention will be clearly and completely described below with reference to the accompanying drawings in the embodiments of the present invention, and obviously, the described embodiments are some, rather than all of the embodiments of the present invention. All other embodiments obtained by those ordinary skilled in the art based on the embodiments of the present invention without making creative efforts fall within the scope of protection of the present invention.

FIG. 1 shows a schematic diagram of an ultrasonic C-scanning testing system, including a 3D printed nickel-based superalloy sample 1, an ultrasonic detector 4, a low-frequency ultrasonic probe 2, an XYZ three-dimensional stepping encoder 3, and a computer 5 with a signal processing software. A detection method including the following detection steps of:
(1) Calibrating an ultrasonic detector, a low-frequency ultrasonic probe and a stepping encoder, encoding and scanning an object to be detected, and collecting ultrasonic A-type echo signals x(t) at M groups of encoded positions;
(2) Performing fast Fourier transform on the acquired echo signals x(t) to obtain an amplitude spectrum A(f) thereof, identifying an effective frequency band [fᵢ, fᵤ] corresponding to half the height of amplitude of the A(f), equally dividing the effective frequency band into N filter bands with a center frequency fᵢ, wherein i is a natural number from 1 to N;
(3) Performing band-pass filtering with the center frequency fᵢ on the signals x(t) using split spectrum processing to decompose the signals x(t) into N sub-signals yᵢ(t) with different center frequencies fᵢ, wherein a filtering bandwidth bi is determined according to a condition that a sub-signal energy Eᵢ and a total energy E of the signals x(t) satisfy 10 lg(E/Eᵢ)<signal-to-noise ratio;
(4) Performing amplitude imaging on sub-signals yᵢ(t) with the same center frequency fᵢ at the M groups of encoded positions to obtain N multi-resolution scanning images Imᵢ with different frequency characteristics;
(5) Sequentially identifying a defect size dᵢ detected with half the amplitude of each of the resolution scanning images Imᵢ, and drawing a curve of the defect sizes dᵢ detected by N ultrasonic scanning images Imᵢ changing with the fᵢ;
(6) Deriving a directivity function D_{c} of the ultrasonic probe based on the acoustic reciprocal principle, wherein the directivity function D_{c} may be determined through numerical simulation, as shown formula (1); in the formula, D represents a size of the probe, having a unit of mm, λ represents a wavelength of a sound wave in a material, having a unit of mm, and θ represents a diffusion angle of the sound wave, having a unit of radian;

$${D}_{c} = function ( D , λ , θ ) \qquad ( 1 )$$

(7) Determining, at a position where a sound velocity of the object to be detected being of ν and a detected depth being of A, a sound beam width corresponding to half the maximum amplitude of D_{c}, that is the defect size dᵢ detected by each the resolution ultrasonic scanning image Imᵢ, and obtaining, according to λf=ν, a quantitative relationship between the detected defect size dᵢ and the center frequency fᵢ, satisfying:

$${d}_{i} = function ( D , {f}_{i} , v , A ) \qquad ( 2 )$$

(8) Substituting a known size D of the ultrasonic probe and a sound velocity ν of a part into formula (2), and linearly fitting the curve of the defect size dᵢ changing with the fᵢ detected in step (5) to determine the unknown parameter A in formula (2);
(9) determining, based on the fitted curve, a resolution frequency fᵢ corresponding to a slope k=−0.01, if an updated sub-signal energy Eᵢ of the split spectrum processing in the bandwidth [fᵢ, fᵤ] satisfies a condition of 10 lg(E/Eᵢ)<signal-to-noise ratio, determining a new bandwidth b through the resolution frequency fₖ, drawing a new scanning image Im, and re-obtaining a quantitative size dₖ of the defect; and
(10) if the determined resolution frequency fₖ is not in the effective frequency band or the condition of 10 lg(E/Eᵢ)<signal-to-noise ratio is not satisfied, extrapolating the fitted curve against the frequency f and deriving it, and the detected defect size dₖ corresponding to the slope k=−0.01 is the quantitative size of the defect.

### Embodiment 1

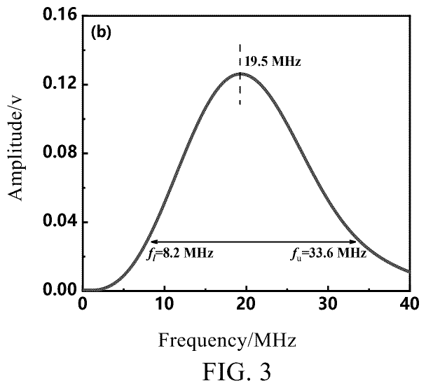

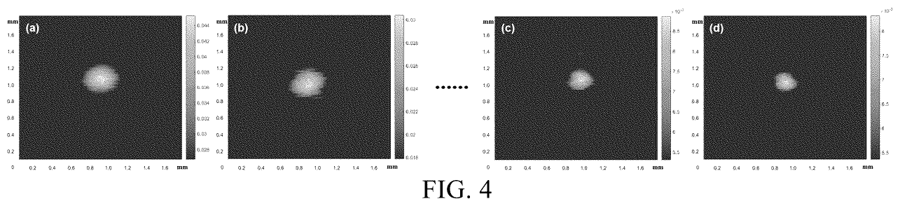

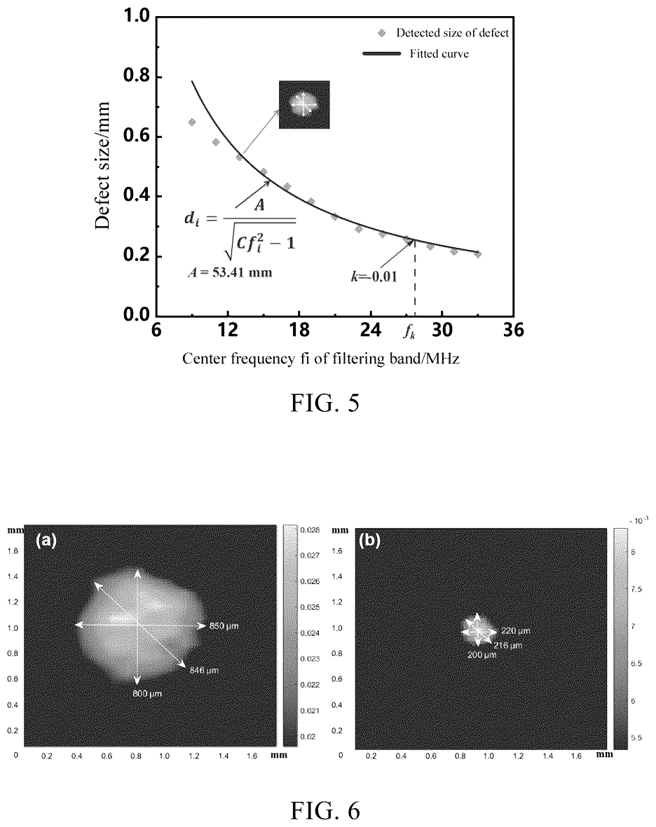

An ultrasonic C-scanning testing system adopted in this embodiment includes a 3D printed nickel-based superalloy sample 1, a low-frequency ultrasonic probe 2 (a water immersion point focusing probe with a nominal frequency of 20 MHZ), an XYZ three-dimensional stepping encoder 3, an ultrasonic detector 4, and a computer 5 with a signal processing software. As shown in FIG. 1, the 3D printed nickel-based superalloy sample was a sample containing pore defects with nominal diameters of Φ100 μm, Φ200 μm, Φ300 μm, Φ400 μm, Φ500 μm, Φ600 μm, Φ700 μm, and Φ800 μm. Detection steps adopted were as follows:
(1) The ultrasonic detector, the water immersion point focusing probe with a nominal frequency of 20 MHz and the XYZ three-dimensional stepping encoder were calibrated, the to-be-detected 3D printed nickel-based superalloy sample was encoded and scanned, and ultrasonic A-type echo signals x(t) at 86×86 groups of encoded positions were collected by the ultrasonic detection system, as shown in FIG. 2.
(2) Fast Fourier transform was performed on the signals x(t) collected in step (1) to obtain an amplitude spectrum A(f) of the signals, as shown in FIG. 3. The center frequency of the water immersion point focusing probe was determined to be 19.5 MHz. An effective frequency band [8.2 MHZ, 33.6 MHZ] corresponding to half the height of the amplitude of A(f) was identified, the effective frequency band was equally divided into 13 filter bands with a center frequency fᵢ=[9 MHZ, 11 MHz, . . . , 31 MHz, 33 MHz], wherein i is a natural number from 1 to 13.
(3) Band-pass filtering with the center frequency fᵢ was performed on the signals x(t) using split spectrum processing to obtain 13 sub-signals yᵢ(t) with different center frequencies fᵢ. A filtering bandwidth bi was determined according to a condition that the sub-signal energy Eᵢ and total energy (E=2.52 mJ) of the signals x(t) satisfy 10 lg(E/Eᵢ)<signal-to-noise ratio of 9.89 dB. For example, when the center frequency f₂=11 MHZ, b₂=4.1 MHz; and when the center frequency f₇=21 MHz, b₇=2.1 MHz.
(4) Amplitude imaging was performed on the sub-signals yᵢ(t) with the same center frequency fᵢ at the 86×86 groups of encoded positions to obtain 13 multi-resolution scanning images Imᵢ with different frequency characteristics, as shown in FIG. 4.
(5) A defect size dᵢ detected by half the amplitude was sequentially identified for each of the resolution scanning image Imᵢ, and a curve of the defect sizes dᵢ detected by the 13 ultrasonic scanning images Imᵢ changing with the fᵢ was drawn. The changing curve of the defect of Φ200 μm is shown in FIG. 5.
(6) A directivity function D_{c} of the point focusing probe was parsed according to the acoustic reciprocal principle, as shown in formula (1), wherein D represents a size of the probe, having a unit of mm, λ represents a wavelength of a sound wave in a material, having a unit of mm, and θ represents a diffusion angle of the sound wave, having a unit of radian.

$${D}_{C , PE} ( θ ) = {jinc}^{2} ( π \frac{D}{λ} sin θ ) \qquad ( 1 )$$

(7) At a position where a sound velocity of the object to-be-detected is ν and a detected depth is A, a sound beam width corresponding to a half of the maximum amplitude of D_{c} was determined, that is the defect size dᵢ detected by each the resolution ultrasonic scanning image Imᵢ, and a quantitative formula (2) between the detected defect size dᵢ and the center frequency fᵢ was derived according to λf=ν, satisfying:

$${d}_{i} = \frac{A}{\sqrt{{( \frac{π D}{1.616 λ} )}^{2} - 1}} = \frac{A}{\sqrt{C \cdot {f}_{i}^{2} - 1}} \qquad ( 2 )$$

$$C = {( \frac{π D}{1.616 v} )}^{2} \qquad ( 3 )$$

(8) The known ultrasonic probe size D=6 mm and the sound velocity ν=5720 m/s of the detected object were substituted into formulas (2) and (3), and the curve of the defect sizes dᵢ changing with the fᵢ detected in step (5) was linearly fitted. The fitted curve of the defect of Φ200 μm is shown in FIG. 5, and the unknown parameter A=53.41 mm in formula (2) was obtained.
(9) A resolution frequency fᵢ=27.2 MHZ corresponding to a slope k of −0.01 was determined based on the fitted curve. When a new spectrum processing bandwidth b is [27.2 MHZ, 33.6 MHZ], the sub-signal energy Eᵢ of split spectrum processing was 0.31 mJ, which satisfies a condition of 10 lg(E/Eᵢ)<9.89 dB, and a new resolution ultrasonic C-scanning image was obtained and a defect size of the image was quantified. Results are shown in FIG. 6. The quantitative size of the defect of Φ800 μm is 832 μm, and the quantitative size of the defect of Φ200 μm is 212 μm.
(10) An actual diameter of each defect is quantified by a laser confocal microscope, and the actual sizes of the defects of Φ200 μm and Φ800 μm are Ø196 μm and Ø774 μm, respectively. The relative error between the detected size and the actual size of the defect of Φ200 μm is 8.1%. The relative error between the detected size and the actual size of the defect of Φ800 μm is 7.5%. It is indicated that the multi-resolution low-frequency ultrasonic C-scanning imaging technology can accurately quantify the sizes of all detected defects.

### APPLICATION EXTENSION

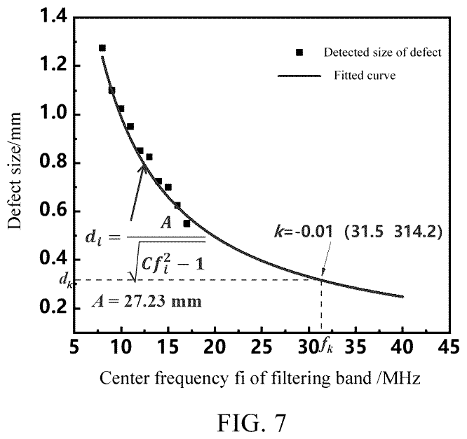

(11) The defect of Φ300 μm is detected by using a low-frequency ultrasonic probe 2 (water immersion point focusing probe with a nominal frequency of 15 MHz), and a curve of a defect size dᵢ in the multi-resolution low-frequency ultrasonic C-scanning imaging detection changing with fᵢ was drawn, as shown in FIG. 7. A resolution frequency fₖ=31.5 MHZ, corresponding to a slope k=−0.01, is determined based on the fitted curve. The resolution frequency fₖ is not in the effective frequency band, the extrapolated defect size dₖ corresponding to fₖ was 314 μm, the actual diameter of the defect of Φ300 μm determined by laser confocal microscope was Φ287 μm, and the quantitative relative error of the defect was less than 9.5%.

1. A quantitative detection method of micro-defects through low-frequency ultrasonic multi-resolution scanning imaging, comprising the following steps of:
(1) calibrating an ultrasonic detector, a low-frequency ultrasonic probe and a stepping encoder, encoding and scanning an object to be detected, and collecting ultrasonic A-type echo signals x(t) at M groups of encoded positions;
(2) performing fast Fourier transform on the acquired echo signals x(t) to obtain an amplitude spectrum A(f) thereof, identifying an effective frequency band [fᵢ, fᵤ] corresponding to half the height of amplitude of the A(f), equally dividing the effective frequency band into N filter bands with a center frequency fᵢ, wherein i is a natural number from 1 to N;
(3) performing band-pass filtering with the center frequency fᵢ on the signals x(t) using split spectrum processing to decompose the signals x(t) into N sub-signals yᵢ(t) with different center frequencies fᵢ, wherein a filtering bandwidth bi is determined according to a condition that a sub-signal energy Eᵢ and a total energy E of the signals x(t) satisfy 10 lg(E/Eᵢ)<signal-to-noise ratio;
(4) performing amplitude imaging on sub-signals yᵢ(t) with the same center frequency fᵢ at the M groups of encoded positions to obtain N multi-resolution scanning images Imᵢ with different frequency characteristics;
(5) sequentially identifying a defect size dᵢ detected with half the amplitude of each of the resolution scanning images Imᵢ, and drawing a curve of the defect sizes dᵢ detected by N ultrasonic scanning images Imᵢ changing with the fᵢ;
(6) deriving a directivity function D_{c} of the ultrasonic probe based on the acoustic reciprocal principle, wherein the directivity function D_{c} is determined through numerical simulation, as shown in formula (1):
$${D}_{C , PE} ( θ ) = {jinc}^{2} ( π \frac{D}{λ} sin θ ) \qquad ( 1 )$$
wherein, D represents a size of the probe, having a unit of mm, λ represents a wavelength of a sound wave in a material, having a unit of mm, and θ represents a diffusion angle of the sound wave, having a unit of radian;
(7) determining, at a position where a sound velocity of the object to be detected being of ν and a detected depth being of A, a sound beam width corresponding to half the maximum amplitude of D_{c}, that is the defect size dᵢ detected by each the resolution ultrasonic scanning image Imᵢ, and obtaining, according to λf=ν, a quantitative relationship between the detected defect size dᵢ and the center frequency fᵢ, satisfying:
$${d}_{i} = \frac{A}{\sqrt{{( \frac{π D}{1.616 λ} )}^{2} - 1}} = \frac{A}{\sqrt{C \cdot {f}_{i}^{2} - 1}} \qquad ( 2 )$$
$$C = {( \frac{π D}{1.616 v} )}^{2} \qquad ( 3 )$$
(8) substituting a known size D of the ultrasonic probe and a sound velocity ν of a part into formula (2), and linearly fitting the curve of the defect size dᵢ changing with the fᵢ detected in step (5) to determine the unknown parameter A in formula (2);
(9) determining, based on the fitted curve, a resolution frequency fₖ corresponding to a slope k=−0.01,
if an updated sub-signal energy Eᵢ of the split spectrum processing in the bandwidth [fₖ, fᵤ] satisfies a condition of 10 lg(E/Eᵢ)<signal-to-noise ratio, determining a new bandwidth b through the resolution frequency fₖ, drawing a new scanning image Im, and re-obtaining a quantitative size dₖ of the defect; and
if the resolution frequency fₖ is not in the effective frequency band or the condition of 10 lg(E/Eᵢ)<signal-to-noise ratio is not satisfied, extrapolating the fitted curve against the frequency f and deriving it, and the detected defect size dₖ corresponding to the slope k=−0.01 is the quantitative size of the defect.
